(19) United States
(12) Patent Application Publication
(10) Pub. No.: US 2018/0030196 A1
(43) Pub. Date: Feb. 1, 2018

(54) METHOD FOR MANUFACTURING A POLYURETHANE-MODIFIED FOAM, FOAM OBTAINED, AND USES

(71) Applicants: SOPREMA, STRASBOURG (FR); UNIVERSITE DE STRASBOURG, STRASBOURG (FR); CENTRE NATIONAL DE LA RECHERCHE SCIENTIFIQUE, PARIS (FR)

(72) Inventors: Alice ARBENZ, MEXIMIEUX (FR); Stephanie LAURICHESSE, STRASBOURG (FR); Remi PERRIN, BOERSCH (FR); Pierre Etienne BINDSCHEDLER, STRASBOURG (FR); Luc AVEROUS, WIWERSHEIM (FR)

(21) Appl. No.: 15/661,329

(22) Filed: Jul. 27, 2017

(30) Foreign Application Priority Data
Jul. 28, 2016 (FR) 16 70413

(51) Int. Cl. C08G 18/08; C08J 9/00; C08J 9/14; C08G 18/42

(52) U.S. Cl. CPC C08G 18/14; C08G 18/4288; C08J 9/0061; C08J 9/141; C08G 2101/0025

(57) ABSTRACT

Disclosed is a method for manufacturing an isocyanurate polyurethane-modified foam, called “PUIR,” including: a) providing an oil or oil mixture at least 50% by weight of the fatty acids having a carbon chain of C18 or more, the fatty acids having an overall iodine number I_{iodine} of at least 100 g of I₂/100 g; b) epoxidating at least 50% of the double bonds in the oil to form the corresponding epoxides; and c) directly reacting, in situ, the epoxides that are obtained above with isocyanate or diisocyanate groups for obtaining corresponding oxazolidone derivatives, without passing through the intermediate formation of polyols obtained from epoxides, in the presence of at least one suitable catalyst and at least one expanding agent, so as to obtain the isocyanurate polyurethane-modified foam “PUIR.” Also disclosed are products, such as rigid insulation material, in particular as a material or panels of rigid insulation for roofing.

### BACKGROUND OF THE INVENTION

### Field of the Invention

This invention relates to the field of the manufacturing of polyurethane-type foams and their uses, in particular in the field of insulation, in particular for thermal insulation of buildings, and in particular insulation products in the form of rigid foams and the rigid insulation panels that are derived therefrom.

### Description of the Related Art

The materials that are currently used in the field of insulation are primarily produced with a base of petroleum-derived polymers.

However, the current synthetic insulation foams have detrimental drawbacks within the context of lasting development.

Actually, these known products use materials derived from fossil and non-renewable raw materials, require large amounts of energy for their production and their transformation, and/or are difficult and even impossible to recycle.

More specifically, the use of synthetic materials often involves the use of materials or organic derivatives obtained from petrochemistry with numerous and costly production steps.

These various negative factors are particularly detrimental within the framework of the ICV (inventory of the life cycle) of products and endow the latter with a quite unfavorable ACV (analysis of the life cycle) result. Actually, the impact on the greenhouse gas emissions (GWP) of a synthetic insulation foam (XPS, PSE or PU) is approximately 10 times higher than that of the natural insulation materials (wood fibers, cellulose wadding): 200 g of equivalent CO₂/20 g of equivalent CO₂ for thermal resistance and an equivalent application (source: FDES [Framework for the Development of Environmental Statistics] present on the INIES [French National Reference on Environmental and Health Data] base in June 2016).

Furthermore, the volatility of the price of petroleum also has a direct impact on the costs of the raw materials that are used.

The use of synthetic polyurethane (PU) foams in the field of insulation has been known for a very long time. The latter are obtained from the reaction between isocyanates and polyols in the presence of an expanding agent.

In the methods for manufacturing these foams that are currently used, it is already possible to use natural renewable materials instead of the—or a portion of the—materials obtained from fossil resources or derivative petroleum products.

In particular, the use of vegetable oils that are processed for transforming them into polyols is known. The vegetable oils for the most part consist of triglycerides that are triesters of fatty acids and glycerol. The general chemical formula is as illustrated in FIG. 1.

The composition of fatty acids in the triglycerides varies and depends on the plant source, the season, and the cultivation conditions (humidity, sunshine, nature of the soil, . . . ).

The most commonly used oils such as the soybean, linseed, canola, or sunflower oils consist essentially of fatty acids that have an aliphatic chain of 18 carbons. Furthermore, the position of the unsaturations varies as well as their number. These double bonds have an impact on the chemical and physical properties of the oils.

To be able to characterize the number of unsaturations that are present in a triglyceride, the iodine number is used. It is determined by the metering of the double bonds by iodine. The conventional experimental method for measuring the iodine number I_{iodine} is the “Wijs Method.” The oils can thus be classified in three categories based on the value of this number (Table 1).

TABLE 1
Classification of Vegetable Oils Based on their Iodine Number

| Type of Oil | Iodine Number I_{iodine} | Example |
|---|---|---|
| Drying | I_{iodine} > 170 | Linseed Oil, Algal Oil |
| Semi-Drying | 170 > I_{iodine} > 100 | Soybean Oil |
| Non-Drying | 100 > I_{iodine} | Palm Kernel Oil |

Based on their origin, the vegetable oils have various fatty acid compositions and therefore a different acid number (Table 2). The most significant structural characteristic, as well as the reactive site of the oils, are the unsaturations.

TABLE 2
Composition of Fatty Acids of Industrial Oils (Vegetable and Microalgae)

| | Fatty | | | | | | | | | | | | | | |
|---|---|---|---|---|---|---|---|---|---|---|---|---|---|---|---|
| | Acid | | | | | | | | | | | | | | |
| | Type % | 10:0 | 12:0 | 14:0 | 14:1 | 16:0 | 16:1 | 18:0 | 18:1 | 18:2 | 18:3 | 20:0 | 20:1 | 20:5 | Others |
| Grain Oils | Canola | — | — | 0.5 | — | 4 | — | 1 | 60 | 20 | 9 | 2 | — | — | — |
| | Sunflower | — | — | — | — | 6 | — | 4 | 28 | 61 | — | — | — | — | — |
| | Palm | 5 | 50 | 15 | — | 7 | — | 2 | 15 | 1 | — | — | — | — | — |
| | Kernel | | | | | | | | | | | | | | |
| | Linseed | — | — | — | — | 5 | — | 4 | 22 | 15 | 52 | — | — | — | — |
| | Soybean | — | — | — | — | 10 | — | 5 | 21 | 53 | 8 | 0.5 | — | — | — |
| Microalgae | Chlorella | — | — | — | — | 31 | 2 | 4 | 43 | 11 | 6 | 0.5 | 0.5 | — | — |
| Oils | Pavlova | 33 | — | — | — | 18 | 11 | — | 4 | 1 | — | — | — | 29 | 5 |
| | Spirulina | — | — | 3 | 6 | 31 | 6 | — | 2 | 48 | — | — | — | — | 5 |

The use of vegetable oil to make polymers is not new. However, in recent years, a specific problem linked to the competition, on the one hand, of this resource with food has appeared. This problem promoted the emergence of microalgae as triglyceride sources.

The main reasons for which the microalgae represent an additional interest in relation to vegetable crops are:
(i) An improved effectiveness coupled to a reduction in costs: the harvesting and transport costs are in general lower than those for grain crops.
(ii) The microalgae crop does not compete with other crops used for food production, and it requires a more moderate surface area compared to other sources. The microalgae can be cultivated in environments that are totally unsuitable for other harvests and often produce a much greater yield.
(iii) Most microalgae have lipid levels of between 20 and 50% of their dry weight, and the time period necessary for doubling the amount of biomass varies from 4 hours to several days.
(iv) Products other than lipids, such as sugars, proteins, etc., can be brought out. In addition, this crop requires neither herbicides nor pesticides.
(v) The microalgae can set the participating CO₂ as well as the reduction in atmospheric levels.

Almost all of the transformations of triglycerides into polyols begin by an extraction of fatty acids and then chemical modifications of these fatty acids for the purpose of grafting hydroxyl groups (alcohol) there. The main modification paths are as follows:
Polyols prepared by epoxidation followed by the ring opening:
   In general, the polyols derived from vegetable oils are prepared by an epoxidation followed by a ring opening. The final properties of the PU that are obtained from these polyols depend on numerous parameters such as the composition of fatty acids of the triglycerides, the percentage of epoxidation (during the passage through the epoxides), and finally, the position and the number of OH groups.
Polyols prepared by hydroformylation and reduction:
   In contrast to the opening of epoxides, which provides secondary alcohols, the hydroformylation makes it possible to synthesize primary alcohols that are more reactive than those that are secondary.
Polyols obtained by ozonolysis and reduction:
   By this path, the polyols that are obtained consist of a maximum of three OH per triglyceride since they are located at the end of each fatty chain.

The hydroxyl groups of the polyols that are present are then reacted with isocyanate groups in a conventional way to form polyurethanes, for example in the form of foams that expand owing to the presence of an expanding agent (chemical or physical) and that then become rigid to form the desired insulation material.

A derivative of these polyurethane foams is the polyisocyanurate foam. The difference between the two essentially resides in the ratio between the alcohol and isocyanate groups that are used (ratio of 1/1 for polyurethanes and 1/3 for polyisocyanurates). The polyisocyanurate foams have improved fire resistance properties.

However, these methods for transforming vegetable oils into polyols have multiple drawbacks to the extent that they are complex and therefore relatively expensive because they are difficult to control in terms of yields and purity of the products obtained.

### SUMMARY OF THE INVENTION

In an unexpected and surprising way, the inventors of this application have discovered that it was possible to manufacture isocyanurate polyurethane-modified foams, called “PUIR,” directly from oils without necessarily having to pass through either steps for extracting fatty acids and then a step of forming polyols by hydroxylating said fatty acids, or the epoxidation of oils and then the opening of epoxy rings.

In addition, the use of specific oils makes it possible to obtain particularly advantageous foams, in particular when oils obtained from microalgae are used. Actually, these oils have profiles in terms of lengths of carbon chains of fatty acids and in terms of unsaturations (number and/or locations of double bonds on the hydrocarbon branches of said fatty acids) that are particularly advantageous for manufacturing the desired foams, with a high degree of cross-linking, without resorting to synthetic products such as those obtained from petroleum and while preserving satisfactory and even enhanced physico-chemical properties for the foams that are obtained.

Taking the opposing view to standard methods, this invention therefore proposes a method for manufacturing an isocyanurate polyurethane-modified foam, called “PUIR,” characterized in that it comprises the steps that consist in:
a) Providing an oil or a mixture of oils of which at least 50% by weight of the fatty acids have a carbon chain of C18 or more and of which the fatty acids have an overall iodine number (I_{iodine}) of at least 100 g of I₂/100 g, preferably at least 125 g of I₂/100 g and more preferably at least 150 g of I₂/100 g,
b) Epoxidating at least 50% of the double bonds that are present in said oil or said mixture so as to form the corresponding epoxides,
c) Directly reacting, in situ, the epoxidized oils that are obtained above with isocyanate or diisocyanate groups for obtaining corresponding oxazolidone derivatives, without passing through the intermediate formation of polyols obtained from epoxides, in the presence of at least one suitable catalyst and at least one expanding agent, so as to obtain said isocyanurate polyurethane-modified foam “PUIR.”

Advantageously, the method according to the invention is characterized in that the oil that is used in step a) is an oil that has at least 25% by weight of fatty acids with a carbon chain of at least C20 (i.e., chains with at least 20 carbon atoms), and of which the fatty acids have an overall iodine number I_{iodine} of at least 200 g of I₂/100 g.

According to another characteristic, the oil that is used in step a) comprises at least one oil that is obtained from at least one microalga.

Advantageously, the microalga(e) is/are selected from the group that is formed by: schizochytrium sp., chlorella sp., porphyridium cruentum, pavlova, and spirulina.

According to another embodiment, the oil that is used in step a) comprises at least one vegetable oil, preferably canola oil, sunflower oil, linseed oil, and/or soybean oil.

According to a variant, step b) for epoxidation is carried out under hot conditions, at a temperature of between 40° C. and 100° C. for at least 2 hours by using a mixture of hydrogen peroxide and acetic acid.

The method that is used for carrying out the epoxidation consists in forming the peracetic acid in situ by the reaction between acetic acid and hydrogen peroxide. The latter is advantageously catalyzed by an ion-exchange resin at 60° C. in toluene for 12 hours (FIG. 2). The epoxide conversion rates can then reach nearly 100%.

Another commonly used method causes peroxoacetic acid and peroxoformic acid to react on the vegetable oils. This method makes it possible to reach conversion levels close to 90%.

In a preferred way, step c) is carried out at ambient temperature, or approximately 20° C., i.e., without heating, with the exothermy of the reaction making it possible by itself to initiate the reaction for formation of oxazolidones.

Actually, when isocyanate groups are heated in the presence of epoxide groups, oxazolidone rings can form at the same time as the formation of isocyanurates and the homopolymerization of epoxides. It is known that the main reactions are carried out one after the other as the temperature increases: in a first step, the formation of isocyanurates (FIG. 3, reaction 1) takes place, then the reaction between the epoxides and the isocyanates occurs to provide the oxazolidone rings (FIG. 3, reaction 2), and finally the isocyanurates decompose by reacting with the epoxides to form oxazolidone rings (FIG. 3, reaction 3).

The catalysts that are commonly used for this type of reaction are imidazole and tertiary amines.

According to another embodiment, one or more external polyols is/are added in step c).

Advantageously, the isocyanate or diisocyanate groups of step c) are provided by aromatic isocyanates or diisocyanates, in particular MDI or TDI.

This invention also has as its object a “PUIR” foam that can be obtained by implementing the method according to the invention.

In a noteworthy way, the “PUIR” foam that is obtained by implementing the method according to the invention is characterized in that it contains at least 10% by mass of an oil that is obtained from microalga(e).

Furthermore, the “PUIR” foam that is obtained by implementing the method according to the invention is characterized in that it has a level of closed cells that is greater than 90%.

Finally, this invention also has as its object the use of a “PUIR” foam according to the invention as a rigid insulation material, in particular as a rigid thermal insulation material for roofing, preferably in the form of rigid thermal insulation panels.

The invention will be better understood, owing to the description below, which relates to preferred embodiments, provided by way of non-limiting examples.

### BRIEF DESCRIPTION OF THE DRAWINGS

The invention will be explained in connection with the attached drawings, in which:

FIG. 1 illustrates the structure of a triglyceride, in which R₁, R₂, and R₃ are the various fatty chains;

FIG. 2 illustrates synthesis of epoxidized triglycerides; and

FIG. 3 illustrates formation of oxazolidones.

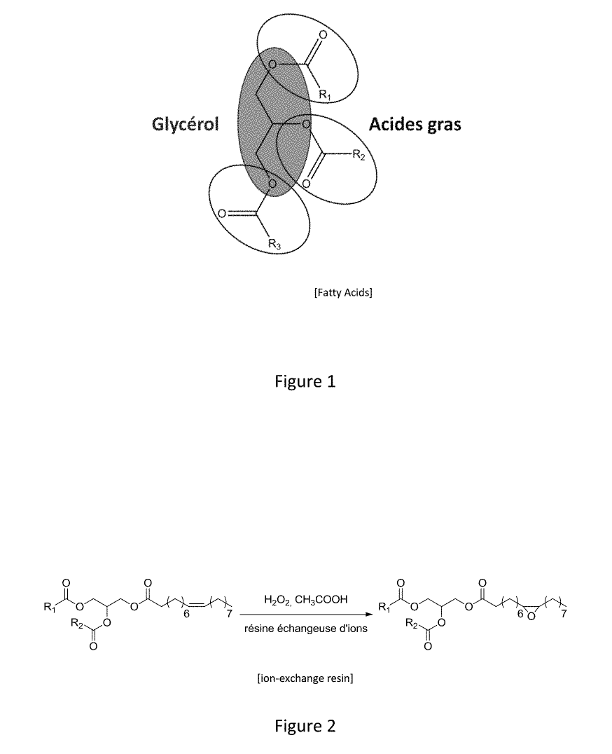

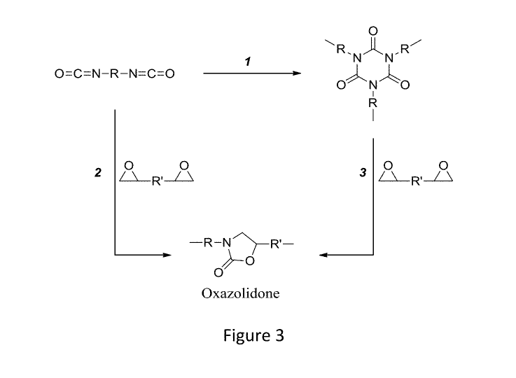

### DESCRIPTION OF PREFERRED EMBODIMENTS

The fact of using an oil of renewable origin with little transformation or few synthetic polyols or none at all makes it possible in particular:
(i) to improve the analysis of the life cycle and the environmental data file on the sealing membranes,
(ii) to be in perfect balance with societal awareness of the environment (Grenelle Forum on the environment),
(iii) to be independent of the provision and cost of fossil resources,
(iv) to use available renewable resources, in particular resources that do not compete with foodstuffs used in other fields, in particular in human and/or animal food (soybean, corn, sunflower . . . ),
(v) to have materials that are thermally stable at higher temperature, this being due to the fact that the oxazolidone bonds are thermally more stable than the urethane or isocyanurate bonds, and
(vi) to have reduced foam prices.

The reactive compounds (unsaturations on the chains of fatty acids) that are present in the natural oils that are used therefore have the advantage of originating from renewable resources, available in industrial amounts and at competitive prices, with these compounds being, for example, present in a large proportion in the canola oils or the microalgae of the families of schizochytrium or spirulines.

### Examples: Manufacturing of a Foam According to the Invention

### Epoxidation of Renewable Natural Oils:

Selection of oils: canola oil “Radia 6101” of the Oleon Company with an I_{iodine}=133 g of I₂/100 g and oil extracted from the schizochytrium sp. microalga with an I_{iodine} of 266 g of I₂/100 g.

The oils are totally epoxidized in a conventional way by the method of in-situ formation of paracetic acid according to the following method:

In a reactor, the oils are mixed with toluene, Amberlite IR-120 H (cation-exchange resin) and acetic acid. The molar ratios between the unsaturations of the oil/Amberlite/acetic acid are as follows: 1/0.5/0.5. The solution is stirred at 70° C., and 1.5 mol of a 30% hydrogen peroxide solution is slowly added to the medium. Once added, the solution is stirred for 7 hours at 70° C. The steps of purification, filtration, and then evaporation of the solvent are then carried out. The canola oils or epoxidized algae oils (respectively HCE and HAE) are thus obtained.

### Production of the Foam:

The isocyanate that is used is a pMDI of the Wanhua Company (Wannate PM-700). The first step is to mix (in % by mass of the total formula)—with a propeller mixer—the above-mentioned epoxidized oil, a possible polyol with a silicone surfactant (1%) with DMCHA catalysts and potassium octoate (0.8%), a physical expanding agent such as isopentane (6%) as well as a chemical expanding agent such as water (0.5%). Once the emulsion is produced, isocyanate is added in a possible epoxy-hydroxyl/isocyanate molar ratio=3.

Foaming is done freely. The reactivity and the characteristics of the foams are compared to a reference foam given with the oxypropylated glycerol polyol (PO) known as “ADIANSOL GO 360” of the CECA Company.

### Results:

| | Reference: | PO/HCE | PO/HAE | PO/HAE |
|---|---|---|---|---|
| | Polyol | Ratio: | Ratio: | Ratio: |
| | (PO) | 75/25 | 75/25 | 10/90 |
| Biosource Content | 4 | 9 | 8 | 29 |
| of Foam | | | | |
| Cream Time | 20 | 24 | 22 | 34 |
| Filtration Time | 129 | 165 | 160 | 225 |
| Stick-Free Time | 238 | 450 | 375 | 535 |
| Level of Closed | 93 | 92 | 93 | 85 |
| Cells (%) | | | | |
| Median Size of | 374 | 441 | 379 | 450 |
| Cells (μm) | | | | |
| Thermal Stability | 310 | 330 | 335 | 350 |
| (° C.), ATG Peak | | | | |
| under Nitrogen | | | | |

Under the industrial conditions of a production line of rigid foam insulation panels, the components are mixed in a high-pressure head (200 bar) at 18° C. The mixture is spread on a 75 μm aluminum wall facing and enters a thickness-shaping zone. An aluminum wall facing is unrolled on the surface of the foam so as to have a thermal insulation panel of the type known as “Efigreen Acier” of the SOPREMA Company.

Advantageously, the foam that is obtained is used in a rigid thermal insulation panel for applications in the building trade. The latter can be used in turn for insulating floors, walls, or roofs, etc.

Of course, the invention is not limited to the embodiments described. Modifications are possible, in particular from the standpoint of the composition of the various elements or by substitution of equivalent techniques, without thereby exceeding the scope of protection of the invention.

1. Method for manufacturing an isocyanurate polyurethane-modified foam, called “PUIR,” comprising:
a) Providing an oil or a mixture of oils of which at least 50% by weight of the fatty acids have a carbon chain of C18 or more and of which the fatty acids have an overall iodine number I_{iodine} of at least 100 g of I₂/100 g,
b) Epoxidating at least 50% of the double bonds that are present in said oil or said mixture so as to form the corresponding epoxides,
c) Directly reacting, in situ, the epoxidized oils that are obtained above with
isocyanate or diisocyanate groups for obtaining corresponding oxazolidone derivatives, without passing through the intermediate formation of polyols obtained from epoxides, in the presence of at least one suitable catalyst and at least one expanding agent, so as to obtain said isocyanurate polyurethane-modified foam “PUIR.”

2. Method according to claim 1, wherein the oil that is used in step a) is an oil that has at least 25% by weight of fatty acids with a carbon chain of at least C20 and whose fatty acids have an overall iodine number I_{iodine} of at least 200 g of I₂/100 g.

3. Method according to claim 1, wherein the oil that is used in step a) comprises at least one oil that is obtained from at least one microalga.

4. Method according to claim 3, wherein the microalga(e) is/are selected from the group that is formed by: schizochytrium sp., chlorella sp., porphyridium cruentum, pavlova and spirulina.

5. Method according to claim 1, wherein the oil that is used in step a) comprises at least one vegetable oil.

6. Method according to claim 1, wherein step c) is carried out at ambient temperature, or at approximately 20° C.

7. Method according to claim 1, wherein the epoxidation step b) is carried out under hot conditions, at a temperature of between 40° C. and 100° C. for at least 2 hours, using a mixture of hydrogen peroxide and acetic acid.

8. Method according to claim 1, wherein one or more external polyols is/are added in step c).

9. Method according to claim 1, wherein the isocyanate or diisocyanate groups of step c) are provided by aromatic isocyanates or diisocyanates.

10. “PUIR” foam that can be obtained by implementing the method according to claim 1.

11. “PUIR” foam that is obtained by implementing the method according to claim 1, wherein the “PUIR” foam contains at least 10% by mass of an oil that is obtained from microalga(e).

12. “PUIR” foam that is obtained by implementing the method according to claim 1, wherein the “PUIR” foam has a level of closed cells that is greater than 90%.

13. A rigid insulation material comprising the “PUIR” foam according to claim 10.

14. The method of claim 1, wherein the fatty acids have an overall iodine number I_{iodine} of at least 125 g of I₂/100 g.

15. The method of claim 1, wherein the fatty acids have an overall iodine number I_{iodine} of at least 150 g of I₂/100 g.

16. The method of claim 5, wherein the vegetable oil comprises canola oil, sunflower oil, linseed oil, and/or soybean oil.

17. The rigid insulation material of claim 13, wherein the rigid insulation material is a rigid thermal insulation material for roofing.

18. The rigid insulation material of claim 17, wherein the rigid insulation material is a rigid thermal insulation panel.

19. Method according to claim 2, wherein the oil that is used in step a) comprises at least one oil that is obtained from at least one microalga.

20. Method according to claim 2, wherein the oil that is used in step a) comprises at least one vegetable oil.
